(19) United States
(12) Patent Application Publication
(10) Pub. No.: US 2024/0174824 A1
(43) Pub. Date: May 30, 2024

(54) Fusion Bonded Epoxy Film and Applications for Same

(71) Applicant: Pipeline Coatings System LLC, Cuddy, PA (US)

(72) Inventors: John G. Gillen, Pittsburgh, PA (US); Don Peter Hart, Jr., Pittsburgh, PA (US); Sean Patrick Richardson, Bridgeville, PA (US)

(21) Appl. No.: 18/283,309

(22) PCT Filed: Mar. 22, 2022
(86) PCT No.: PCT/US22/21320

§ 371 Date: Sep. 21, 2023

Related U.S. Application Data
(60) Provisional application No. 63/163,977, filed on Mar. 22, 2021.

(51) Int. Cl. C08J 5/18; B29C 63/10; C08G 59/24; C08G 59/40; C08K 3/013; C08K 3/22; C08K 3/34; C08K 3/36; F16L 58/10

(52) U.S. Cl. CPC C08J 5/18; B29C 63/105; C08G 59/245; C08G 59/4021; C08K 3/013; C08K 3/22; C08K 3/346; C08K 3/36; F16L 58/1054; C08J 2363/00; C08K 2003/2241; C08K 2201/019

(57) ABSTRACT

An uncured or partially cured, flexible fusion bonded epoxy (“FBE”) film for application to a metal substrate, such as an oil and gas pipeline pipe and pipeline pipe weld areas includes an epoxy resin, a curing agent, accelerator, filler, and optional additives. The epoxy can include a blend of solid epoxy resin and liquid epoxy resin. Also included are methods of applying the FBE film to pipe in the shop and on field joints. Methods also include using a flexible, electric heat blanket or heat belt to cure FBE film and epoxy liquid coatings on field joints.

### CROSS REFERENCE TO RELATED APPLICATIONS

This application claims the benefit of U.S. Provisional Application No. 63/163,977, filed Mar. 22, 2021, which is incorporated herein by reference in its entirety.

### BACKGROUND OF THE INVENTION

### Field of the Invention

This invention relates to a fusion bonded epoxy (“FBE”) film, methods of making same, methods of using same for applications to substrates, including application of the FBE film on pipeline coating applications, and methods of improving the application of an epoxy-based coating on a metal substrate, such as pipelines and pipeline weld areas.

### Description of Related Art

Due to the inherent risk of transporting oil, natural gas and other natural gas liquids by pipeline, the metal pipes used to transport these products require additional corrosion protection to ensure their safety. Pipeline pipe for oil and gas may be about 8 to 42 inches in diameter, and thus, circumference may be about 25 to about 130 inches. Pipe for water and other applications may be up to about 80 inches in diameter.

In the United States, oil and gas pipelines (on land) generally utilize a dual corrosion protection system: a specialized epoxy coating provides the main protection, while as an additional measure the pipes have electrical cathodic protection (“CP”). A simple explanation of CP is that metal can only rust when it gives off electrons. If electricity is run through the metal it is unable to rust. A CP system is installed on the oil and gas pipelines to prevent rust.

The specialized epoxy coating is commonly known as fusion bonded epoxy (“FBE”). FBE is typically applied to a pipeline as a powder composed primarily of solid epoxy resin and a curing package, such as dicyandiamide with an accelerator. The dicyandiamide together with the accelerator is known as the ‘curing agent’ or ‘curing agent package.’ This curing agent package needs a temperature above about 250° F. to melt and start to cure.

To manufacture FBE powder, the solid epoxy resin is heated to its melting point (approximately 220° F.), mixed with the curing agents then quickly chilled to stop any reaction between the epoxy and the curing agents. After the mixture is solidified, it is then ground into a powder. The powder is typically about 100μ to about 1000μ in size. See e.g., U.S. Pat. No. 3,904,346 to Shaw et al. The solid epoxy resin component of the FBE powder has a high molecular weight and is very friable.

At a pipe coating facility, the metal pipe is typically treated by sand blasting, washing and cleaning and then heating to about 450° F. Then, the FBE powder is dry sprayed onto the hot pipe where it quickly melts and flows into a continuous coating, the curing agent can react with the epoxy resin to fully coat the pipe. Pipeline pipe is typically made in 40 foot lengths. At the pipe coating facility, typically the whole length of the pipe is coated except for the last 3 inches of either end of the 40 foot long pipe section. The ends of the pipe are left uncoated so that when the pipe sections are welded together in the field, a clean weld can be achieved.

When an oil and gas pipeline is constructed, the factory applied FBE coated pipe is transported out to the field and then all the sections of pipe are welded together. Each weld may be inspected by X-ray or other means to ensure structural integrity. The weld area (and uncoated adjacent area) is then cleaned and sand blasted to prepare it for coating in the field. This coating is called a field joint coating. There are two main types of field joint coating: the FBE powder coating described above or a two-part liquid epoxy coating. The two parts of the liquid coating are “A side” which is a liquid epoxy resin and the “B side” which is the liquid amine based curing agent. The liquid two-part epoxy is mixed shortly before application. Both methods of field joint coating have their limitations.

The coating of the weld area with FBE powder is difficult and capital intensive because of the high curing temperature. The pipe has to be preheated to about 450° F. with an induction coil and then powder spray coated with specialized equipment. An example of coating the pipeline weld area and using induction heating may be seen here: https://youtu.be/a4jSz-YaVMo. However, there is the belief that the FBE powder provides better corrosion protection than the two-part liquid epoxy. This may be due to the uniformity of coating and material used in the coating facility and in the field.

The coating of the weld area with the two-part liquid epoxy can be done either by hand brush application or by special liquid spray equipment. When applied by hand brush, the epoxy coating is usually supplied in one liter kits, consisting of two different pails, one with the A side resin and another of the B side curing agent. The two sides are thoroughly mixed together and then applied to the weld area. The kits are supplied in one liter quantities as the material immediately begins to react and is unusable after 10-20 minutes. With the one liter kits, there may be a lot of excess material wasted depending on the circumference of the pipe. Additionally, the time to mix and apply the coating is manpower intensive. When applied by special liquid spray equipment, the two parts are kept separate from each other, and are only mixed together at the last second at the spray head nozzle. Spray application is capital intensive and requires a number of workers to manage the equipment, however it has less wasted coating material but there is still some material wasted due to various reasons.

U.S. Pat. No. 5,589,019 to Van Beersel et al. describes a method for applying a polymeric tape material composed of either polyester, polypropylene or polyethylene to a pipeline pipe field joint using a device that comprises a frame and rollers. Other references generally describe two-part liquid coatings for pipeline and field joint applications, FBE powders, FBE alternatives, and methods of applying the same, including US 2007/0241558A1 to Nestegard et al., WO 2009/143602A1 to Cunningham et al., US 2007/0034316A1 to Perez et al., US 2007/0277733A1 to Wood et al., U.S. Pat. No. 5,178,902 to Wong et al., U.S. Pat. No. 8,522,827 to Lazzara et al., and U.S. Pat. No. 5,709,948 to Perez et al.

There is a need for a FBE coating that may be applied to pipelines in both the facility and in the field that does not require extensive material, manpower, temperature, curing time, and equipment. Such FBE coating applications should minimize wasted material, manpower, curing time and temperature, and specialized equipment rendering the FBE application process more effective and efficient than the currently-employed process.

### SUMMARY OF THE INVENTION

One non-limiting embodiment of the present invention is an uncured or partially-cured, flexible fusion bonded epoxy (“FBE”) film for application to a metal substrate, such as a pipeline pipe and pipeline pipe weld areas, wherein the FBE film comprises: about 40 to 80% by weight epoxy resin, about 5 to 25% resin modifiers and tougheners, about 3 to 10% by weight dicyandiamide or other classes of curing agents, about 1 to 4% by weight accelerator, about 20 to 50% by weight filler, and 0-1% by weight additives, wherein the FBE film has a thickness of about 0.001 to about 0.05 inches, and wherein the epoxy film has a curing temperature of about 275° F. to about 450° F., and wherein the FBE film is a blend of solid epoxy resin, liquid epoxy, and resin modifiers and tougheners, mixed with the curing agent, such as dicyandiamide, accelerator, filler, and any additive.

In certain non-limiting embodiments, the FBE film is made by heating a solid form of the epoxy resin to a temperature corresponding to about a melting point of the epoxy resin, mixing the epoxy resin with the curing agent, such as dicyandiamide, the accelerator, the filler, and the optional additive, and then quickly casting the mixture onto a belt at a chilled temperature, wherein the belt is lined with a thin plastic film that acts as a backing surface and allowing the casted fusion bonded epoxy film to solidify, wherein the cooling time is about 30 seconds to about two minutes. The thin plastic film backing surface may have a silicone release layer having a thickness of about 0.003 inches. The FBE film may be rolled in spools having a width of about 10 inches for applications involving field joint welding, or it may have a width of about 1 foot to about 4 foot for applications involving coating 40 feet long pipe in a shop.

Another non-limiting embodiment of the invention is a method of coating a pipe to be used in an oil and gas pipeline, comprising: providing a piece of pipe having a length of about 40 foot, preparing the pipe to be coated, including sandblasting and heating the pipe within a range of about 400° F. to about 475° F., such as about 450° F. in an oven, removing the heated pipe from the oven, applying a fusion bonded epoxy film to the heated pipe, wherein the epoxy resin film is a blend of solid epoxy resin and liquid epoxy and resin modifiers, mixed with the curing agent, such as dicyandiamide, accelerator, filler, and optional additives casted on a thin plastic backing surface, wherein the applying comprises wrapping the film around the pipe with ½ overlap along the length of the pipe and removing the plastic backing, and allowing the film to cure into a fusion bonded epoxy coating on the pipe having a thickness of about 0.007 to about 0.02 inches. The method of coating may optionally comprise rotating the pipe as the FBE film is applied.

In certain non-limiting embodiments, a method of coating a field joint of a section of an oil and gas pipeline, comprises: welding two pieces of pipe together forming a weld area, sand blasting the weld area, wrapping a fusion bonded epoxy film having a width of about 10 inches around the weld area and cutting it to fit the weld area, wherein the fusion bonded epoxy film comprises a blend of solid epoxy resin, liquid epoxy, and resin modifiers and tougheners, mixed with dicyandiamide, accelerator, filler, and an optional additive casted on a thin plastic backing surface, and wherein the fusion bonded epoxy film is about 0.02 to about 0.05 inches thick, keeping the plastic backing surface, optionally wrapping a shrinkable release layer around the fusion bonded epoxy, applying a heat source to the weld area to achieve a temperature of at least about 350° F. for about 30 to about 60 minutes (optionally heating to about 425° F. to 450° F. for about 2 to 6 minutes), removing the heat source, and removing the shrinkable release layer. The method may further comprise preheating the weld area to about 100° F. before wrapping the film around the weld area and wherein the preheating is performed with a flexible, electric heat blanket or heat belt comprising heating wires. The wrapping may be performed manually. The method may use a flexible, electric heat blanket or heat belt heating wires as its heat source. The heat blanket or heat belt may be sized to wrap around the weld area. For instance, the heat blanket can be about 18 inches in width and about the length of the circumference of the pipe at the weld area. The method may optionally comprise, after the removing the plastic backing surface step, applying an abrasion resistant overcoat over the wrapped film. Since the heat blanket and heat belt are electric, it may be powered by a portable generator in the field.

Another non-limiting embodiment of the invention includes an electric flexible heat blanket for curing epoxy coatings on pipeline pipes and pipe welds, comprising heating wires and being about 18 inches in width and about the length of the circumference of the pipe at the weld area.

A further non-limiting embodiment of the invention includes a method of coating a field joint of a section of an oil and gas pipeline, comprising: welding two pieces of pipe together forming a weld area, sand blasting the weld area, applying a liquid epoxy coating to the weld area by brushing or spraying a two-part liquid coating, wherein one part is a mixture of a liquid epoxy resin and wherein the second part is a liquid amine based curing agent, wrapping a tightly woven heat resistant fabric layer of either nylon or polyester around the coating, optionally wrapping a shrinkable release layer around the heat resistant fabric layer, applying a heat source to the weld area to achieve a temperature of about 140° F. to 190° F. for about 30 to about 60 minutes, removing the heat source, removing the shrinkable release layer, removing the tightly woven heat resistant fabric layer, and exposing a cured epoxy coating.

The two-part liquid coating method may use the electric heat blanket or heat belt of the present invention as the heating source. The method may also involve preheating the weld area before applying the two-part coating. The method may also comprise, after the FBE coating has cured, applying an abrasion resistant overcoat and using the flexible, electric heat blanket or heat belt to cure the abrasion resistant overcoat.

Another non-limiting embodiment of the invention is a partially-cured, flexible fusion bonded epoxy film for application to a substrate, comprising: about 40 to 80% by weight epoxy resin, about 5 to 25% by weight resin modifiers and tougheners, about 3 to 10% by weight amine curing agent, such as dicyandiamide, about 1 to 4% by weight accelerator, about 20 to 50% by weight filler, and about 0-1% by weight additives, wherein the epoxy film has a thickness of about 0.001 to about 0.05 inches, and wherein the epoxy film has a curing temperature of about 275° F. to about 450° F., wherein the fusion bonded epoxy film is rolled into a roll comprising a backing surface and a layer of flexible epoxy-based abrasion resistant overcoat FBE film.

In certain non-limiting embodiments, the invention also includes the following clauses.

Clause 1: A partially-cured, flexible fusion bonded epoxy film for application to a substrate, comprising: about 40 to 80% by weight epoxy resin; about 5 to 25% by weight resin modifiers and tougheners: about 3 to 10% by weight curing agent; about 1 to 4% by weight accelerator; about 20 to 50% by weight filler; and about 0-1% by weight additives, wherein the epoxy film has a thickness of about 0.001 to about 0.05 inches, and the epoxy film has a curing temperature of about 275° F. to about 450° F., and wherein the epoxy resin is a blend of solid epoxy resin and liquid epoxy resin.

Clause 2: The film of clause 1, wherein the epoxy film is casted on a plastic backing surface.

Clause 3: The film of any one of the preceding clauses, wherein the plastic film is about 4 mils in thickness and comprises a silicone release coating.

Clause 4: The film of any one of clauses 2 and 3, wherein the epoxy film casted on the plastic film is a roll of material.

Clause 5: The film of clause 4, wherein the roll of material is cut to a width of about 10 inches, or a width of about 1 foot to about 4 feet.

Clause 6: The film of any one of the preceding clauses, further comprising an abrasion resistant overcoat film applied over a surface of the epoxy film.

Clause 7: The film of clause 6, wherein the abrasion resistant overcoat film comprises an epoxy resin.

Clause 8: The film of any one of the preceding clauses, wherein the epoxy film is free of fiberglass and carbon fibers.

Clause 9: A metal substrate coated with the fusion bonded epoxy film according to any one of the preceding clauses.

Clause 10: The metal substrate of clause 9, wherein the metal substrate is a pipeline pipe or a pipeline weld.

Clause 11: A method of coating a pipe to be used in an oil and gas pipeline, comprising: providing a piece of pipe; preparing the pipe to be coated, comprising sandblasting and heating the pipe within a range of about 400° F. to 475° F. in an oven, removing the heated pipe from the oven; applying a fusion bonded epoxy film to the heated pipe, wherein the epoxy resin film comprises a blend of solid epoxy resin and liquid epoxy resin, a curing agent, accelerator, filler, and an optional additive that is casted on a plastic backing surface, wherein the applying comprises wrapping the film around the pipe and removing the plastic backing; and allowing the film to cure into a fusion bonded epoxy coating on the pipe

Clause 12: The method of clause 11, wherein the piece of pipe has a length of about 40 feet

Clause 13: The method of any one of clauses 11 or 12, wherein the pipe is heated to about 450° F. in the oven

Clause 14: The method of any one of clauses 11-13, wherein the pipe fusion bonded epoxy coating has a thickness of about 0.008 inches.

Clause 15: The method of any one of clauses 11-14, further comprising rotating the pipe as the epoxy film is applied.

Clause 16: A method of coating a field joint of a section of an oil and gas pipeline, comprising: welding two pieces of pipe together forming a weld area; sand blasting the weld area and an adjacent area that is adjacent to the weld area; wrapping a fusion bonded epoxy film having a width around the weld area and the adjacent area and cutting it to fit the weld area, wherein the fusion bonded epoxy film comprises a blend of solid epoxy resin and liquid epoxy, a curing agent, accelerator, filler, and an optional additive that is casted on a plastic backing surface, and wherein the fusion bonded epoxy film is about 0.02 to about 0.05 inches thick; removing the plastic backing surface; applying a heat source to the weld area to achieve a temperature of at least about 350° F. for about 30 to about 60 minutes; and removing the heat source.

Clause 17: The method of clause 16, wherein the fusion bonded epoxy film has a width of about 10 inches.

Clause 18: The method of any one of clauses 16 and 17, further comprising wrapping a shrinkable release layer around the fusion bonded epoxy after removing the plastic backing surface and removing the shrinkable release layer after removing the heat source.

Clause 19: The method of any one of clauses 16-18, wherein the shrinkable release layer comprises a polyester and wherein the shrinkable release layer is about 0.001” to 0.005” thick and begins to shrink at 150° F. and has a shrink percentage of about 5% to 20%.

Clause 20: The method of any one of clauses 16-19, further comprising preheating the weld area to about 100° F. before wrapping the fusion bonded epoxy film around the weld area.

Clause 21: The method of any one of clauses 16-20, wherein the preheating is performed with a flexible, electric heat blanket or heat belt comprising heating wires.

Clause 22: The method of any one of clauses 16-21, wherein the wrapping is performed manually.

Clause 23: The method of any one of clauses 16-22, wherein the heat source is a flexible, electric heat blanket or heat belt comprising heating wires

Clause 24: The method of any one of clauses 16-22, wherein the heat source is an induction coil.

Clause 25: The method of clause 23, wherein the heat blanket is sized to wrap around the weld area and adjacent area, and is about 18 inches in width and about the length of the circumference of the pipe at the weld area.

Clause 26: The method of any one of clauses 16-25, further comprising, after the removing the plastic backing surface step, applying an abrasion resistant overcoat over the wrapped film.

Clause 27: A method of coating a field joint of a section of an oil and gas pipeline, comprising: welding two pieces of pipe together forming a weld area; sand blasting the weld area and an adjacent area that is adjacent to the weld area; applying a liquid epoxy coating to the weld area by brushing or spraying a two-part liquid coating, wherein one part is a mixture of a liquid epoxy resin and wherein the second part is a liquid amine based curing agent; wrapping a woven heat resistant fabric layer comprising nylon, polyester, or a combination thereof around the liquid epoxy coating; applying a heat source to the weld area to achieve a temperature of about 100° F. for 5 approximate minutes, followed by heating to a temperature of about 150° F. for 5 minutes, followed by heating to a temperature of about 190° F. for about 20 minutes; removing the heat source; removing the woven heat resistant fabric layer; and exposing a fully cured epoxy coating.

Clause 28: The method of clause 20, further comprising wrapping a shrinkable release layer around the heat resistant fabric layer before applying the heat source and removing the shrinkable release layer after removing the heat source.

Clause 29: The method of any one of clauses 27 and 28, wherein the shrinkable release layer comprises a polyester.

Clause 30: The method of any one of clauses 27-29, wherein the heat source is a flexible, electric heat blanket or heat belt comprising heating wires, or an induction coil.

Clause 31: The method of clause 30, wherein the heat blanket is sized to wrap around the weld area and adjacent area, and is about 18 inches in width and about the length of the circumference of the pipe at the weld area.

Clause 32: The method of any one of clauses 27-31, further comprising preheating the weld area before applying the liquid epoxy coating to the weld area.

Clause 33: The method of clause 32, the weld area is preheated to a temperature of about 150° F.

Clause 34: The method of any one of clauses 32-33, wherein the preheating is performed with flexible, electric heat blanket or heat belt comprising heating wires.

Clause 35: The method of any one of clauses 27-34, further comprising, after the epoxy coating has cured, applying an abrasion resistant overcoat over the cured fusion bonded epoxy coating, wrapping a shrinkable release layer around the abrasion resistant overcoat, applying a heat source to the weld area to achieve a temperature of at least about 150° F., wherein the heat source is a heat blanket or heat belt; and allowing the abrasion resistant overcoat to cure.

Clause 36: A partially-cured, flexible fusion bonded epoxy film for application to a substrate, comprising: about 40 to 80% by weight epoxy resin; about 5 to 25% by weight resin modifiers and tougheners: about 3 to 10% by weight amine curing agent, such as dicyandiamide; about 1 to 4% by weight accelerator; about 20 to 50% by weight filler; and about 0-1% by weight additives, wherein the epoxy film has a thickness of about 0.001 to about 0.05 inches, and wherein the epoxy film has a curing temperature of about 275° F. to about 450° F., wherein the fusion bonded epoxy film is rolled into in roll comprising a backing surface and a layer of flexible epoxy-based abrasion resistant overcoat film.

Clause 37: An electric, flexible heat blanket for curing epoxy coatings on pipeline pipes and pipe welds being about 18 inches in width and about the length of the circumference of the pipe at the weld area and being powered by a portable generator.

Clause 38: A method of obtaining a partially-cured, flexible fusion bonded epoxy film for application to a substrate, comprising heating a solid form of the epoxy resin according to any one of clauses 1-8 to a temperature corresponding to about a melting point of the epoxy resin, mixing the epoxy resin with the curing agent, the accelerator, the filler, and the optional additive, and then casting the mixture onto a belt at chilled temperature, wherein the belt is lined with a plastic film that acts as a backing surface and allowing the casted fusion bonded epoxy film to cool and solidify, wherein the cooling time is about 30 seconds to about 2 minutes.

Clause 39: The method of clause 38, further comprising allowing the fusion bonded film to cool to ambient temperature on the plastic film

Clause 40: The method of clause 39, further comprising rolling the fusion bonded film cooled on the thin plastic film into a roll of material, and cutting the roll to a width of about 1 foot to about 4 foot.

### BRIEF DESCRIPTION OF THE DRAWINGS

FIG. 1 is a photograph of a two-part liquid epoxy coating of the prior art.

FIGS. 2-3 are photographs of one non-limiting embodiment of the present invention, in which a peel ply layer was used in curing a two-part liquid epoxy coating with a flexible, electric heat blanket.

FIG. 4 illustrates a non-limiting embodiment of flexible, electric heat blanket.

FIG. 5 illustrates a non-limiting embodiment of flexible, electric heat belt.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about” if not explicitly stated. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As indicated, the invention relates to a fusion bonded epoxy (“FBE”) film. The FBE film may be applied to any metal substrate, such as a pipeline pipe and pipeline pipe weld area, and also include any industrial or commercial application, including applications to metal I-beams, metal bridges, and any other suitable application.

Current technology exists to manufacture uncured or partially cured “B-staged” epoxy film that is flexible and formable. This epoxy film technology is used as an adhesive in the computer and semi-conductor industry and also in the automotive manufacturing industry. Additionally, the composite industry utilizes epoxy film in the manufacture of “prepreg” fiberglass and carbon fiber sheets. For example, Chinese Application CN102927407A describes the use of epoxy film in the manufacture of “prepreg” fiberglass and carbon fiber sheets.

It is undesirable to include fiberglass in formulating a FBE film for application onto oil and gas pipelines. It is believed that the fiberglass included in the epoxy film described in Chinese Application CN102927407A would interfere with the cathodic protection (“CP”) that is applied to pipelines installed in the field to prevent rust. Fiberglass is used as an electrically insulating material, therefore, it is believed that the epoxy film described in Chinese Application CN102927407A that includes fiberglass would be inoperable for coatings on oil and gas pipeline pipes. Additionally undesirable in formulating a FBE film is the inclusion of carbon fibers due to their potential to cause galvanic corrosion on the steel pipe. As such, in certain non-limiting embodiments, the FBE film comprises less than 1 weight %, less than 0.5 weight %, less than 0.1 weight %, less than 0.05 weight %, or less than 0.01 weight % of any fiberglass and/or carbon fibers, based on the total weight of the film. It is appreciated that the amount is low enough that it would prevent any interference with cathodic protection of the substrate. A preferred FBE film of the present invention is therefore free of any fiberglass and/or carbon fibers.

As used herein, an “uncured” or “partially cured,” as in about 1-20% cured (such as 1-20% cured), flexible FBE film is manufactured for later application to a substrate. The FBE film is made and cut into particular lengths and widths for later application onto a substrate and differs from a coating that is applied and cured directly onto the substrate to form a coating in real time. In particular, the FBE film may be used on metal substrates, as a pipeline pipe and pipeline pipe weld areas, but can also include any suitable, substantially uniform substrate, such as a utility pole, such as a metal utility pole, other metal pipe, a coil of steel, or as a composite, or as a repair or replacement patch to any composite or surface such as a wind mill blade. Once applied to the substrate, the FBE film will be subjected to heat to allow the coating to form and cure on the substrate.

A partially-cured, flexible fusion bonded (“FBE”) epoxy film for application to a substrate, can include: about 40 to 80% by weight epoxy resin (for example within a range of from 40 to 80% by weight epoxy resin), about 5 to 25% by weight resin modifiers and tougheners (for example within a range of from 5 to 25% by weight resin modifiers and tougheners), about 3 to 10% by weight curing agent (for example within a range of from 3 to 10% by weight curing agent), such as dicyandiamide, amidoamine or imidazole, about 1 to 4% by weight accelerator (for example within a range of from 1 to 4% by weight accelerator), about 20 to 50% by weight filler (for example within a range of from 20 to 50% by weight filler), and about 0-1% by weight additives (for example within a range of from 0 to 1% by weight additives). The FBE film has a thickness of about 0.005 to about 0.05 inches and a curing temperature of about 275° F. to about 450° F. (for example within a range of from 275° F. to 450° F.).

The proposed epoxy film can be composed of a blend of solid epoxy resin and optional liquid epoxy that is mixed with a curing package, such as a dicyandiamide (dicy) with an accelerator. First, the solid epoxy resin will be heated to the melting point of the solid epoxy resin, such that some of the solid may be melted into a liquid form, mixed with the curing agent, modifier, accelerator, filler, and any additives and then cast onto a chilled belt. The thickness of the FBE film is controllable to within 0.0005 inches. At the time of manufacture of the FBE film it will be cast onto a thin plastic film with a silicone release layer to protect it from being deformed and from sticking upon the adjacent layer when is wound into coils of film.

Epoxy resins of the FBE film preferably comprise compounds which contain one or more 1,2-, 1,3- and 1,4-cyclic ethers, which also may be known as 1,2-, 1,3- and 1,4-epoxides. The 1,2-cyclic ethers are preferred. Such compounds can be saturated or unsaturated, aliphatic, alicyclic, aromatic or heterocyclic, or can comprise combinations thereof. Compounds that contain more than one epoxy group (i.e., polyepoxides) are preferred.

A wide variety of commercial epoxy resins are available and are listed or described in, e.g., the Handbook of Epoxy Resins, by Lee and Neville, McGraw-Hill Book Co., New York (1967); Epoxy Resins, Chemistry and Technology, Second Edition, C. May, ed., Marcell Decker, Inc., New York (1988); and Epoxy Resin Technology, P. F. Bruins, ed., Interscience Publishers, New York, (1968). Any of the epoxy resins described therein may be useful in preparation of the FBE film.

Examples of suitable curing agents include thermally latent curing agents well known to those of ordinary skill in the art and, as will be apparent to one skilled in the art, are preferably selected taking into consideration the residence time and temperature profile in the compounding equipment. Non-limiting examples of such suitable curing agents are imidazole, dicyandiamide, and cyanoguanidines (commonly known as DICY) available from CVC Specialty Chemicals Inc. under the trade name DDA or from Air Products and Chemicals Inc. of Allentown, PA, under the trade name Amicure CG 1200. Hydrazide compounds and hydrazines such as adipic acid dihydrazide (ADH) and isophtalic di-hidrazide (IDH) both available from A&C Catalysts Inc. of Linden, NJ, phenoloic hardeners such as the DEH line of products (DEH 85) from DOW Chemicals, anhydrides such as methyl hexahydrophtalic anhydride, nadic methyl anhydride and methyl tetrahydrophtalic anhydride, available from Dixie Chemical Company Inc. of Houston, TX may also be used as curing agents. Aliphatic and aromatic primary and secondary amines and their reaction products with epoxy resins, which are well known to act as curing agents for epoxy resins, may also be employed.

The function of the filler in the composition is to improve the physical properties of the coating, especially its impact resistance, corrosion resistance, and/or hardness. Suitable fillers that may be used include calcium carbonate, calcium sulfate, barium sulfate, clays, for example montmorillonite and bentonite, glass beads and bubbles, microbeads, and mica, silica, feldspar and calcium metasilicate also known as wollastonite.

It is appreciated that curing time is a function of curing temperature as is known in the art. The FBE film may be cured at a range of temperatures (about 150° F. to about 450° F., for example within a range of from 150° F. to 450° F.) over a range of times (about 1 to about 40 minutes, for example within a range of from 1 to 40 minutes). Snap cures are specifically contemplated for curing the FBE film. For example, at 350° F., two minute cures may be achieved. At higher temperatures, even faster cures may be achieved. For example, in order to achieve a snap cure, imidazole may be used as the curing agent. For shorter cure times, the curing agent should generally make up a higher weight percentage of the formulation.

Generally, the machines used to manufacture epoxy film make the film 60 inches wide and then the film can be slit into various widths. The FBE film will have a backing surface, such as a thin plastic film with a silicone release layer, and thus can be spun into a roll or spool of material, with an optional center tube. Widths of the rolls can be adjusted by application. For example, in the field, a width of about 10 inches is contemplated to accommodate a field joint weld and adjacent uncoated area that is 6 inches wide allowing for 2 inches of overlap onto the factory applied FBE coating. In the shop, a spool of FBE film may be about 1 to about 4 feet in width (for example within a range of from 1 to 4 feet) for wrapping around the length of the pipe. Other widths are possible. The length of the FBE film is at least the circumference of the pipeline to be wrapped, and, of course, it may be longer. The thin plastic film with a silicone release layer may be about 0.003 to about 0.015 inches thick (for example within a range of from 0.003 to 0.015 inches thick).

Other applications of the FBE film are contemplated, including using a FBE film to perform a repair of a section of corroded pipeline pipe, including digging up of the installed pipe and using the FBE film as a patch to perform a repair. The FBE film may be cut to suitable dimensions for use on repairs and may be greater in thickness than the FBE film contemplated to wrap around the weld areas.

The formula of this epoxy film is very similar to FBE powder coating, except for the inclusion of lower molecular weight solid epoxy resin and/or the liquid epoxy resin and resin modifiers which give it the flexibility. As such, it can be considered a FBE film or tape. The FBE film, when kept at a low temperature (approximately 40° F.) remains flexible and usable for about 6 to about 12 months. Additionally, as it is in film form versus powder, it will be less susceptible to absorbing moisture, which can ruin powdered FBE and its final properties.

The FBE film may be wrapped around the oil and gas pipe and then cured by heat. In one non-limiting embodiment, the FBE film will be used at pipe coating factories to wrap the pipe exiting the oven. Instead of dry spray applying the FBE powder, the FBE film will be wound onto the pipes as it comes out from the heating oven. Pipe plants already have the capability to spin the pipes as they run along the line to ensure even heating and application of the powder coating. Making use of this existing technology to rotate and advance the pipe, as the FBE film is applied to the pipe, by wrapping the pipe, the thin plastic film with a silicone release layer is removed.

The FBE film in the pipe shop application will have a thin plastic film with a silicon release layer that it has been cast onto and an optional layer of polyester mesh netting. In this application, the width will be about 1 to about 4 feet (example within a range of from 1 to 4 feet) and the thickness of the FBE film is about 0.004 to about 0.009 inches (for example within a range of from 0.004 to 0.009 inches). The pipe will be rotated at typical speeds known in the art and the FBE film is unwound onto the pipe, with ½ overlay, wrapping the pipe until a coating of about 0.008 to about 0.018 inches (for example within a range of from 0.008 to 0.018 inches) is achieved for the length of the pipe. The pipe will not be coated on the last several inches, preferably 3 inches, on the respective ends so as to achieve a clean field joint weld.

Machines to unwind rolls of material are known and may be used herein. The process may be semi-automatic and semi-manual in that there are known devices to unroll adhesive-like materials that have a backing surface, and it is known how to rotate and advance the pipe. An example of applying FBE powder to a pipe in a shop may be seen at https://youtu.be/GL4bLNIZda8.

Wrapping may have to be somewhat manual and will account for the overlay of the FBE film in which to achieve the desired thickness of the coating. The wrapping process will also account for any safety issues in the pipe being hot leaving the oven. The wrapping process will also account for leaving the ends un-coated—the process of which is well known in the industry. One method includes manually applying protective removal tape to the last several inches of the ends of the pipe before applying a powder or film.

For field joint coating, the FBE film will be supplied on a roll that is about 10 inches wide, with a thickness of about 0.02 to about 0.05 inches (for example within a range of from 0.02 to 0.05 inches), preferably about 0.03 inches. The last three inches of the pipe are typically bare of any factory coating. Those areas are optionally sand blasted to clean off rust and dirt. After welding and treatment to the weld area and this adjacent uncoated area, the area to be wrapped may be optionally preheated to about 100° F., but at a minimum heated to 5° F. above the dew point temperature. After the optional pre-heating, the FBE film will be wrapped around the welded area of the pipe and cut to the proper length, which may correspond to the pipes' circumference. Manual wrapping is contemplated, with an optional physical rolling of the FBE film down onto the area to be wrapped. The thin plastic film with a silicone release layer may be removed from the FBE film as it is applied over the weld area. Additionally, an optional shrinkable release layer may be wrapped around the FBE film/weld area. The shrinkable release layer may be a polymeric tape film or other suitable material and is typically about 0.003 to about 0.015 inches thick. Alternatively, the thin plastic film with a silicone release layer may remain on the FBE film before applying the heat source. The purpose of the shrinkable release layer or leaving the plastic backing layer in place is to prevent the epoxy coating melting onto the heat source. The shrinkable release layer, if used, should be wide enough to protect the epoxy from spreading too thin upon heating/curing. The shrinkable release layer may be about 18 inches in width in which to cover the weld area and also to overlap on the pre-coated pipe to allow for shrinkage during heating. Additionally, any other methods may be used to prevent the film from spreading too thin, including applying pressure to the weld area, such as by using bands or otherwise physically surrounding the weld area.

After the optional shrinkable release layer is applied, a flexible, electric heat blanket may be wrapped around the shrinkable release layer/FBE film/weld area. A heat blanket may be used to heat the FBE film and pipe to approximately 350° F. for about 30 to about 60 minutes for the complete cure of the FBE film. Alternatively, an induction coil could heat the weld area as is known in the art.

The shrinkable release layer may be used to keep the epoxy from ruining the heat blanket. Also, as the optional release layer shrinks, it will physically squeeze the FBE film onto the pipe, while stopping it from dripping off the pipe and achieving a better coating.

For field joint coating, the FBE film can be quickly applied manually, with the optional use of a manual or automatic roller to eliminate any air gaps. With the FBE film, very little epoxy material is wasted. Additionally advantageous is that the FBE film doesn't require skilled applicators and has lower capital cost than traditional fusion boned epoxy FBE coatings. Laborers may be trained to apply the FBE film and used instead of skilled painters, saving labor costs in applying a FBE film as compared to traditional two-part liquid epoxy coatings.

The heat blanket may be an electric, variable resistor, flexible heat blanket made of silicone rubber encapsulating heating wires. Silicone rubber heat blankets are commercially available for various other applications, including, for example, to heat 55 gallon metal drums. A heat blanket for use on pipeline heating may be customized to a preferred size and shape. For example, a heat blanket may be about 12-20 inches (for example within a range of from 12 to 20 inches), preferably about 18 inches in width and about the length of the circumference of the pipe at the weld area, which is roughly about 25 to about 130 inches. Because silicone rubber heat blankets are significantly less expensive than cumbersome, heavy, industrial, induction coil heaters that traditionally are used in the field for pipeline heating, multiple silicone heat blankets may be used on various weld sections of the pipeline at one time, reducing time in performing and curing the multiple field joint coatings. The silicone rubber heat blanket may be used to perform the pre-heating step and for performing the curing step. Alternatively, traditional propane torch heating may be used to pre-heat the weld area to about 100° F., but at a minimum 5° F. above the dew point temperature to remove any moisture on the pipe.

Alternatively, the electric, flexible heat blanket may be a carbon nanotube heat blanket. Alternatively, the electric, flexible heat blanket may comprise polyimide and acrylic covering the circuitry of wires. Alternatively, the electric, flexible heat blanket may include aluminized cloth exteriors and fiberglass insulation. Any resistor-based flexible heat blanket may be sized to about 12-20 inches, preferably about 18 inches in width and about the length of the circumference of the pipe at the weld area, which is roughly about 25 to about 250 inches. Any suitable flexible, electric heat blanket that may be powered by a portable generator may be used regardless of materials covering the circuitry of wires. Several flexible, electric heat blankets that are powered by a portable generator may be used in the field together, regardless of type, reducing the total time in performing and curing the filed joint coatings.

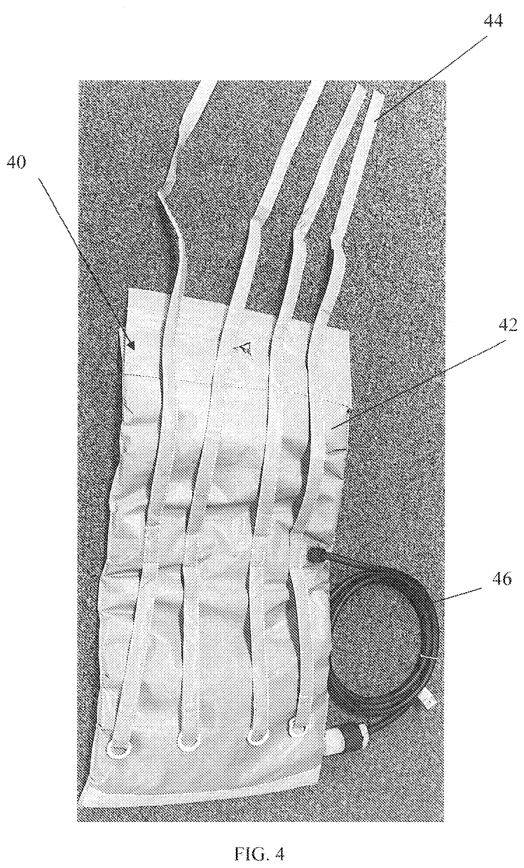

A non-limiting embodiment of a flexible, electric heat blanket 40 is illustrated in FIG. 4, which is described further herein in the examples. As shown in FIG. 4 and described in the examples section, a non-limiting embodiment of a flexible, electric heat blanket 40 comprises an elongated flexible body 42 with heating wires 44.

After optional pre-heating and the application of the FBE film and application of the optional shrinkable release layer, the flexible, electric heat blanket is wrapped around the pipe weld area. The flexible, electric heat blanket has a controller. Thus, the temperature can be controlled and adjusted during the cure. For example, if there is a pre-heating set, then the pipe will be about 100° F. Once the FBE film is applied and the heat blanket wrapped around the pipe, the temperature on the controller of the heat blanket may be set to about 150° F. to start the softening and flow of the FBE film into the sandblasted profile of the pipe. The temperature is held at 150° F. for about 5 to 10 minutes. Then, the temperature is increased to about 350° F. and held there for about 30 to 60 minutes. Next, the heat blanket is removed and the shrinkable release layer is removed.

A non-limiting embodiment of a flexible, electric heat blanket 40 is illustrated in FIG. 4, which is described further herein in the examples. As shown in FIG. 4 and described in the examples section, a non-limiting embodiment of a flexible, electric heat blanket 40 comprises an elongated flexible body 42 and straps 44 with heating wires 46.

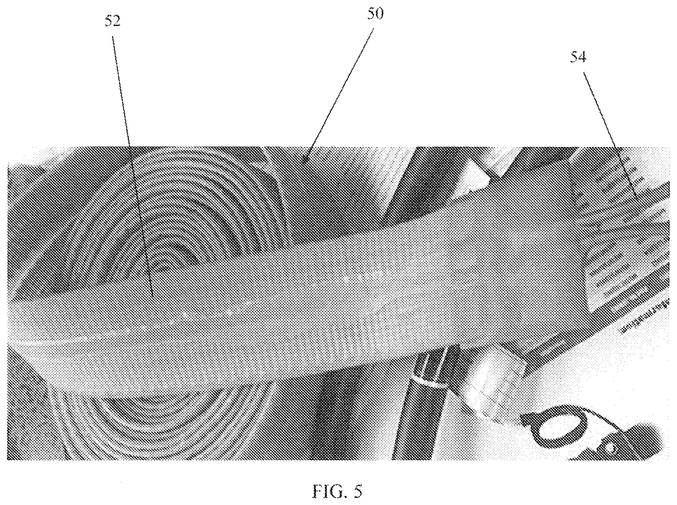

An alternative of using a flexible, electric heat blanket is using a flexible electric heat belt. The electric heat belt can have various dimensions for the desired use. For example, the electric heat belt can be within a range of about 4-8 inches wide and up to about 50 feet long. The heat belt may be used in a variety of applications, on any number of cures in the field. Because it can be wrapped around any diameter of pipe, multiple times, in confined spaces, it can be more versatile than the heat blanket. The temperature control of the heat belt combined with its flexible and dimensions make it possible to use on curing repairs, field joint coatings, and in many other pipeline uses. A non-limiting embodiment of a flexible, electric heat belt 50 is illustrated in FIG. 5. As shown in FIG. 5, a non-limiting embodiment of an electric heat belt 50 comprises a flexible body 52 with heating wires 54.

As another example, if there is no pre-heating step, the temperature on the controller of the heat blanket or heat belt may be set to about 150° F. to start the flow of the FBE film. The temperature is held at 150° F. about 5 to 10 minutes. Then, the temperature is increased to about 350° F. and held there for about 30 to 60 minutes.

As an additional optional layer, an Abrasion Resistant Overcoat (“ARO”) FBE film may be applied on top of the FBE film. If an ARO layer is used, it will be applied before the optional shrinkable release layer. AROs are typically applied over top of the field joint coatings on welds, and are used when pipes are pulled underground underneath an obstruction where a trench cannot be dug, i.e., a lake, highway, or river. Liquid two-part AROs require even longer cure times for their full properties to be realized. Heat curing dramatically shortens the cure time. Therefore, using the heat blanket or heat belt to cure both the FBE film and the ARO together in a single heating step of about 30-60 minutes is a time savings.

AROs are typically epoxy-based coatings, but are generally harder and denser than FBE coatings. AROs are primarily used to prevent scratching and gouging, while FBE coatings act as a corrosive protective layer.

As another embodiment, since AROs are typically epoxy-based, an ARO film may be “partially cured” and cast onto a backing surface to make a flexible ARO film. The ARO film may be made similar to how the FBE film is made by heating the epoxy resin to close to or about its melting temperature and then blending it with curing agents, tougheners, modifiers, fillers, and optional additives, and then quickly casting it onto a chilled thin plastic layer. This ARO may be cut to about 10 inches in width and rolled into a roll for later use, including curing on any suitable substrate, including wrapping applications to a pipe and/or pipe weld area.

As another non-limiting embodiment, the FBE film and the ARO film may be made separately as separate films as described herein. Next, the FBE film and the ARO film may be combined together at ambient temperatures with a single backing surface that is wound into a roll for later use. The combined FBE/ARO film may be cut to 10 inches in width and to the length of the circumference of the pipe. This combined FBE/ARO film may be applied to any suitable substrate, including pipes and the weld area in the field.

In certain non-limiting embodiments, the present invention also includes a use of the heat blanket or heat belt to cure a two-part traditional liquid epoxy coating. The use of two-part liquid epoxy coating for field joint coatings on pipelines is known. One of the downsides to two-part epoxy coatings is the time necessary for cure, which is temperature dependent. At 70° F. ambient temperature, it can take about two and half hours before the pipeline can be dropped into its trench and covered with soil, at 50° F. it can be about 4-6 hours for enough cure. A lot of times, the pipes are preheated to 150° F. using large propane torches, however this does not give consistent results and the heat might dissipate before the epoxy coating is fully cured. Heat blankets are marketed for the use of curing the epoxy coating and pipeline in this industry. However, there is very low use of the heat blankets in the industry because of one drawback. Using a heat blanket for curing field joint coatings may result in a number of pits or shallow indentations in the coating. This is most likely due to the liquid accelerators volatizing to a gas and then being trapped by the release liner. These pits would not pass inspection, which is required for all oil and gas pipelines.

One non-limiting embodiment of the present invention is using a flexible, electric heat blanket or heat belt as described herein to cure a two-part liquid epoxy coating while using an additional layer of a heat resistant fabric to allow the release of the volatizing accelerators while keeping the heated liquid epoxy coating trapped next to the pipe. The additional layer of a heat resistant fabric may be referred to as a peel ply.

A heat blanket or heat belt to cure the liquid epoxy coating may utilize a peel ply to prevent pitting by allowing the release the volatizing accelerator but keeping the epoxy liquid in place. Most liquid epoxy coatings include an accelerator in the B side (curing agent side) of the two-part liquid epoxy coating. The accelerator does not cross link into the resin, but instead volatizes off during cure as a gas or remains in the coating and reduces the properties of the coating. Using a heat blanket or heat belt to cure the liquid two-part epoxy coating with just a solid plastic release liner to protect the heat pad from the epoxy, the accelerator would be trapped in between the cured coating and the release liner, causing pitting and low spots in the coating. This would not be acceptable as it might allow corrosion to occur in the low spot. A peel ply, which is used extensively in the composite industry, is a tightly woven heat resistant fabric of either nylon or polyester. The peel ply would be wrapped around the liquid two-part epoxy coating first, followed by the release liner. The peel ply allows the accelerator to escape but does not let the epoxy coating to penetrate through the fabric. Once the coating is fully cured, the fabric can be peeled off of the surface. The finished coating has a uniform texture (looks like one side of the fabric) with no pitting or thin spots. Optionally, in addition to the peel ply and release liner, a heat shrinkable tape could also be wrapped around the outside of the release liner which would squeeze the epoxy coating to the pipe and squeeze out any entrapped air. The peel ply may be supplied in an 18-inch roll that is sized to be the length of the circumference of the pipe.

In a two-part liquid coating application, an optional shrinkable release liner serves to prevent dripping or sagging of the coating. The peel ply fabric has four additional uses with liquid two-part epoxy coating for pipelines. It can be wrapped around liquid epoxy coatings that are not heat cured. Further, the peel ply: (1) may help prevent sagging and dripping of the coating during cure; (2) may protect the curing coating from rain and snow, which could potentially damage the properties of the coating; (3) may prevent dust and debris from being blown onto the coating during cure, ruining the coating; and (4) may protect against certain insects getting trapped in the coating that are attracted to the amine smell of the curing agent during cure, saving time in potentially having to remove the insects and recoat the pipe.

The flexible, electric heat blanket or heat belt has a controller. Thus, the temperature can be controlled. For example, if there is a pre-heating set, then the pipe will be heated to about 100° F. before the liquid two-part coating is applied. The temperature on the controller of the heat blanket or heat belt will be set to about 100° F. to start once the two-part liquid epoxy coating, release liner, and peel ply are applied. The temperature is first set at approximately 100° F. for 5 minutes to initiate gelling of the epoxy coating. Then, the heat blanket or heat belt is set at 150° F. for about 5 minutes to set the epoxy coating. Then, the temperature is increased to about 190° F. and held there for about 20 minutes to fully cure the epoxy coating. It is important to ramp up the temperature of the heat blanket or heat belt as described, otherwise if the temperature is set too high too soon, the epoxy coating will become too thin in viscosity and could spread more than desired. Additionally, the temperature of the heat blanket or heat belt should not be set above 200° F. during curing of liquid two-part epoxy coating as certain performance enhancing additives begin to volatize off at this temperature.

As another example, if there is no pre-heating step, the temperature on the controller of the heat blanket or heat belt will be set to about 100° F. to start once the two-part liquid epoxy coating, release liner, and peel ply are applied. The temperature is first set at approximately 100° F. for 5 minutes to initiate gelling of the epoxy coating, then the heat blanket or heat belt is set at 150° F. for about 5 minutes to set the epoxy coating. Then, the temperature is increased to about 190° F. and held there for about 20 minutes to fully cure the epoxy coating.

Finally, as an optional step in the two-part liquid coating application, after the corrosion resistant two-part epoxy coating has cured, the heat blanket or heat belt may be used to cure a liquid two-part epoxy abrasion resistant overcoat (“ARO”) coating. As has been discussed herein, AROs are applied over top of the field joint coatings on welds, and are used when pipes are pulled underground underneath an obstruction where a trench cannot be dug, such as a river. AROs require even longer cure times typically than corrosion resistant coatings for their full properties to be realized. Heat curing dramatically shortens the cure time. A peel ply would not be necessary in curing the ARO, but is optional in that it may help prevent sagging and dripping.

If an ARO coating is used, the temperature on the controller of the heat blanket or heat belt will be set to about 100° F. to start once the two-part liquid epoxy coating, release liner, and peel ply are applied. The temperature is first set at approximately 100° F. for 5 minutes to initiate gelling of the epoxy coating. Then, the heat blanket or heat belt is set at 150° F. for about 5 minutes to set the epoxy coating. Then, the temperature is increased to about 190° F. and held there for about 20 minutes to fully cure the epoxy coating.

### Examples

### Example 1

A 30 mB FBE film was made with the following ingredients. The epoxy resin was heated to 190° F. for 45 minutes and then mixed together with the remaining ingredients and stirred. The mixture was then cast onto steel panel and baked at 350° F. for 60 minutes.

| | | Amount | Amount (wt %) |
|---|---|---|---|
| Ingredient | name | used (wt %) | range |
| epoxy resin | Bisphenol “A” Epoxy | 5.07% | 2-10% |
| | resin - Epon 828 - | | |
| | Hexion Corp. | | |
| | Bisphenol “F” Epoxy | 9.52% | 5-15% |
| | resin - Epalloy 8230 - | | |
| | Huntsman Advanced | | |
| | Materials | | |
| | Solid Bisphenol “A” | 38.1% | 35-55% |
| | Epoxy resin - DER 661- | | |
| | Olin Corp | | |
| modifiers and | Rubber modified | 6.30% | 4-8% |
| tougheners | Epoxy Resin - Hypox | | |
| | RM22 - Huntsman | | |
| | Advanced Materials | | |
| | Epoxy Functional | 1.27% | 1-4% |
| | Diluent | | |
| curing agent | Accelerated | 3.05% | 3-8% |
| | Dicyandiamide - | | |
| | Epicure P-108 - Hexion | | |
| | Corp | | |
| Fillers/ | Chrome Green - Green | 0.76% | 0.5-2.0% |
| pigments | Pigment - Lansco Green | | |
| | 305 | | |
| | Quartz - Novacite 1250 - | 26.40% | 20-30% |
| | Malvern Minerals | | |
| | Titanium Dioxide - | 3.05% | 2.0-5.0% |
| | R706 type | | |
| | Treated Clay - Luvogel | 0.50% | 0.50-1.0% |
| | 4 - Lehman & Voss | | |
| additives | Siloxane Polymer | 1.02% | 0.5-2.0% |
| | modifier | | |
| | KBM-403 - 3- | 1.02% | 0.5-2.0% |
| | Glycidoxypropyl | | |
| | trimethoxysilane - Shin- | | |
| | Etsu America | | |

The coating was tested using the ASTM G95 Standard Test Method for Cathodic Disbondment Test of Pipeline Coatings (Attached Cell Method), one of the primary tests used for evaluating epoxy coatings for steel pipelines and passed. The third column in the table is the weight percentage actually used in this example, while the final column in the table represents the range that may be used for each of the ingredients in the formulation.

### Example 2

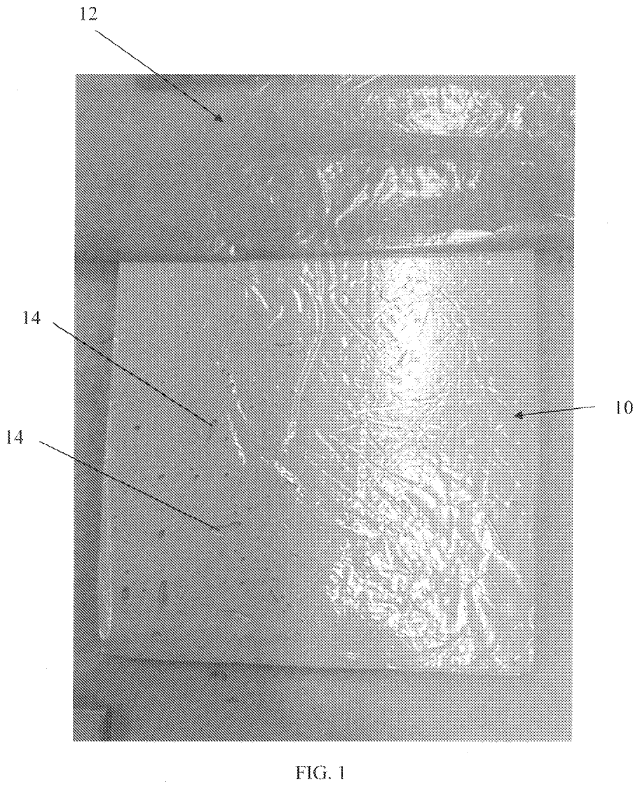

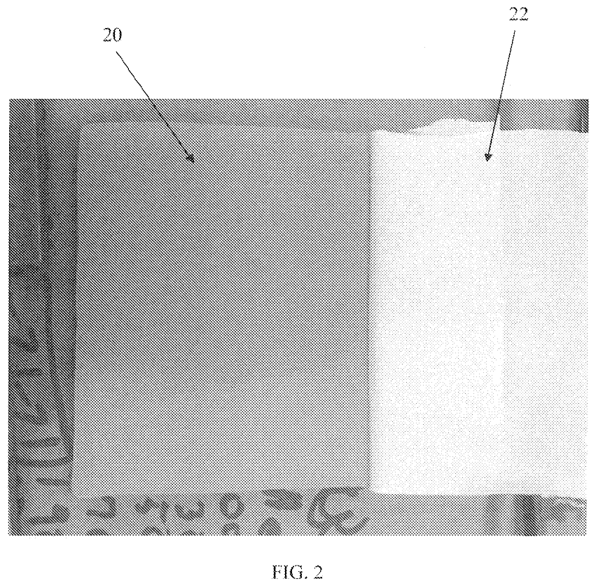

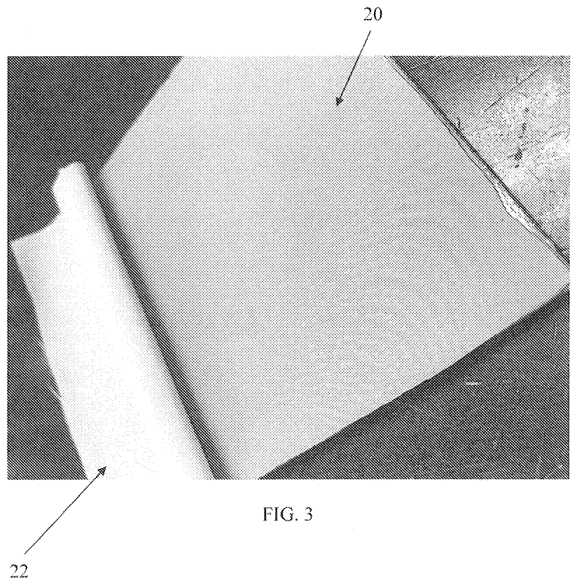

FIGS. 1-3 show two panels coated with two-part liquid epoxy that have been cured with a flexible, electric heat blanket at 190° F. for 30 minutes. The curing for the coating 10 shown in FIG. 1 only uses a plastic release liner 12. FIG. 1 shows all the pot marks 14 in the coating 12. The pitting is most likely due to the volatizing accelerator being trapped. FIGS. 2-3 show a coating 20 wherein a peel ply 22 was applied prior to curing the same two-part liquid epoxy at 190° F. for 30 minutes with the same flexible, electric rubber electric heat blanket. FIGS. 2-3 show the elimination of the pitting on the coating 20 that results from the use of the peel ply layer 22. FIG. 3 shows a uniform pattern in the coating 20 that results from the use of the fabric peel ply layer 22.

As indicated, the two-part liquid epoxy was cured with a flexible, electric heat blanket. An example of such a heat blanket is illustrated in FIG. 4. In one non-limiting embodiment, referring to FIG. 4, the flexible, electric heat blanket 40 can comprise an elongated flexible body 42 with heating wires 44.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

The invention claimed is:

1. A partially-cured, flexible fusion bonded epoxy film for application to a substrate, comprising:
about 40 to 80% by weight epoxy resin;
about 5 to 25% by weight resin modifiers and tougheners:
about 3 to 10% by weight curing agent;
about 1 to 4% by weight accelerator;
about 20 to 50% by weight filler; and
about 0-1% by weight additives,
wherein the epoxy film has a thickness of about 0.001 to about 0.05 inches, and the epoxy film has a curing temperature of about 275° F. to about 450° F., and wherein the epoxy resin is a blend of solid epoxy resin and liquid epoxy resin.

2. The film of claim 1, wherein the epoxy film is casted on a plastic backing surface.

3. The film of claim 2, wherein the plastic film is about 4 mils in thickness and comprises a silicone release coating.

4. The film of claim 2, wherein the epoxy film casted on the plastic film is a roll of material.

5. The film of claim 4, wherein the roll of material is cut to a width of about 10 inches, or a width of about 1 foot to about 4 feet.

6. The film of claim 1, further comprising an abrasion resistant overcoat film applied over a surface of the epoxy film.

7. The film of claim 6, wherein the abrasion resistant overcoat film comprises an epoxy resin.

8. The film of claim 1, wherein the epoxy film is free of fiberglass and carbon fibers.

9. A metal substrate coated with the fusion bonded epoxy film according to claim 1.

10. The metal substrate of claim 9, wherein the metal substrate is a pipeline pipe or a pipeline weld.

11. A method of coating a pipe to be used in an oil and gas pipeline, comprising:
providing a piece of pipe;
preparing the pipe to be coated, comprising sandblasting and heating the pipe within a range of about 400° F. to 475° F. in an oven,
removing the heated pipe from the oven;
applying a fusion bonded epoxy film to the heated pipe, wherein the epoxy resin film comprises a blend of solid epoxy resin and liquid epoxy resin, a curing agent, accelerator, filler, and an optional additive that is casted on a plastic backing surface, wherein the applying comprises wrapping the film around the pipe and removing the plastic backing; and
allowing the film to cure into a fusion bonded epoxy coating on the pipe.

12. The method of claim 11, further comprising rotating the pipe as the epoxy film is applied.

13. A method of coating a field joint of a section of an oil and gas pipeline, comprising:
welding two pieces of pipe together forming a weld area;
sand blasting the weld area and an adjacent area that is adjacent to the weld area;
wrapping a fusion bonded epoxy film having a width around the weld area and the adjacent area and cutting it to fit the weld area, wherein the fusion bonded epoxy film comprises a blend of solid epoxy resin and liquid epoxy, a curing agent, accelerator, filler, and an optional additive that is casted on a plastic backing surface, and wherein the fusion bonded epoxy film is about 0.02 to about 0.05 inches thick;
removing the plastic backing surface;
applying a heat source to the weld area to achieve a temperature of at least about 350° F. for about 30 to about 60 minutes; and
removing the heat source.

14. The method of claim 13, further comprising wrapping a shrinkable release layer around the fusion bonded epoxy after removing the plastic backing surface and removing the shrinkable release layer after removing the heat source.

15. The method of claim 14, wherein the shrinkable release layer comprises a polyester and wherein the shrinkable release layer is about 0.001” to 0.005” thick and begins to shrink at 150° F. and has a shrink percentage of about 5% to 20%.

16. The method of claim 13, further comprising preheating the weld area to about 100° F. before wrapping the fusion bonded epoxy film around the weld area.

17. The method of claim 16, wherein the preheating is performed with a flexible, electric heat blanket or heat belt comprising heating wires.

18. The method of claim 13, wherein the heat source is a flexible, electric heat blanket or heat belt comprising heating wires, or an induction coil.

19. The method of claim 13, further comprising, after the removing the plastic backing surface step, applying an abrasion resistant overcoat over the wrapped film.

20. A method of coating a field joint of a section of an oil and gas pipeline, comprising:
welding two pieces of pipe together forming a weld area;
sand blasting the weld area and an adjacent area that is adjacent to the weld area;
applying a liquid epoxy coating to the weld area by brushing or spraying a two-part liquid coating, wherein one part is a mixture of a liquid epoxy resin and wherein the second part is a liquid amine based curing agent;
wrapping a woven heat resistant fabric layer comprising nylon, polyester, or a combination thereof around the liquid epoxy coating;
applying a heat source to the weld area to achieve a temperature of about 100° F. for 5 approximate minutes, followed by heating to a temperature of about 150° F. for 5 minutes, followed by heating to a temperature of about 190° F. for about 20 minutes;
removing the heat source;
removing the woven heat resistant fabric layer; and
exposing a fully cured epoxy coating.

21. The method of claim 20, further comprising wrapping a shrinkable release layer around the heat resistant fabric layer before applying the heat source and removing the shrinkable release layer after removing the heat source.

22. The method of claim 20, wherein the shrinkable release layer comprises a polyester.

23. The method of claim 20, wherein the heat source is a flexible, electric heat blanket or heat belt comprising heating wires, or an induction coil.

24. The method of claim 20, further comprising preheating the weld area before applying the liquid epoxy coating to the weld area.

25. The method of claim 24, wherein the preheating is performed with flexible, electric heat blanket or heat belt comprising heating wires.

26. The method of claim 20, further comprising, after the epoxy coating has cured, applying an abrasion resistant overcoat over the cured fusion bonded epoxy coating, wrapping a shrinkable release layer around the abrasion resistant overcoat, applying a heat source to the weld area to achieve a temperature of at least about 150° F., wherein the heat source is a heat blanket or heat belt; and allowing the abrasion resistant overcoat to cure.
